(19) United States
(12) Patent Application Publication
(10) Pub. No.: US 2001/0021686 A1
(43) Pub. Date: Sep. 13, 2001

(54) CARBON-GRAPHITE MATERIAL, METHOD FOR PRODUCING SAME AND ITS USE

(76) Inventors: GUNTER RINN, LAHNAU (DE); HANS LIPPER, LAUTERBACH (DE); RAINER SPERLING, BIEGERTAL (DE); KARL-HEINZ SAUER, BIEBERTAL (DE)

Correspondence Address: BURTON SCHEINER, DENNISON MESEROLE POLLACK AND SCHEINER, 612 CRYSTAL SQUARE 4, 1745 JEFFERSON DAVIS HIGHWAY, ARLINGTON, VA, 22202

(21) Appl. No.: 08/878,939

(22) Filed: Jun. 19, 1997

Related U.S. Application Data
(63) Continuation of application No. 08/338,759, filed on Nov. 10, 1994, now abandoned.

(30) Foreign Application Priority Data
Nov. 11, 1993 (DE) P 43 38 447.1

(51) Int. Cl. C04B 35/52; C01B 31/04

(52) U.S. Cl. 501/99; 501/90; 423/448

(57) ABSTRACT

The invention relates to a carbon-graphite material with an embedded additive. So that the carbon-graphite material is distinguished by a low coefficient of friction and low wear, it is proposed that the additive is one or several synthetic mechanically resistant materials of a mean grain size between 0.1 to 10 μm.

The invention relates to a carbon-graphite material with an embedded additive, a method for producing same as well as the use of carbon-graphite materials.

Two basic methods are distinguished in the production of carbon-graphite materials. In one, additives are added to carbon filler materials, such as coke, graphite and carbon black and they are mixed with a binder, such as pitch or a synthetic resin. In the other, self-sintering raw materials, so-called meso-phases, which can also be mixed with additives, are used as starter materials.

Mixtures containing binders are ground to defined distributions of grain sizes, raw materials free of binders are customarily bought with the required distribution of grain sizes. In each case the mixtures are pressed into shaped bodies and these are treated exclusively thermally, i.e. they are cured and/or coked and possibly graphitized in order to be possibly impregnated with metals of synthetic resins later, wherein the synthetic resin can be additionally coked. The maximum temperature during production of the carbon-graphite materials of the invention is limited by the decomposition temperature of the additives.

Based on the composition and manufacturing processes, the carbon-graphite materials are ceramic materials having a great chemical stability, temperature resistance, sturdiness, hardness and thermal conductivity. These materials are also distinguished by low coefficients of thermal expansion and high resistance to temperature changes.

Because of its special crystalline structure, graphite has lubricating properties. However, friction and the wear of carbon-graphite materials are very much dependent on their composition, thermal treatment, the impregnating agent and the contact material against which they move. It is also known that inorganic components have a considerable effect on friction and wear. Tribologically effective steps, however, have not been clearly identified.

Sources of inorganic components are contamination of the raw carbon materials, parts rubbed off grinders and the directed use of additives as modifiers of the coefficient of friction (see “The Friction and Wear Properties of Meso-Carbon Microbeads/Carbon Fibre/Ceramic Composites”, Hirohisa Miura et al., Wear of Materials, ASME 1991, pp. 143 et seq.).

A metal-filled carbon brush for small motors is known from DE 40 25 367 Al. To improve exclusively the electrical properties and the service life of the carbon brush, without taking into consideration the wear of the contact material, for example a commutator, it is provided that the starter material of the carbon brush is mixed with carbides. Preferably the proportion of carbides lies in the range between 1.0 and 15.0 percent by weight at a particle size of less than 50 μm.

Further graphite materials having carbide additions can be found in U.S. Pat. No. 4,670,201, EP 0 507 564 Al, U.S. Pat. No. 2,992,901 or DE 27 27 314 B2. However, the carbide additions in these cases are used either as a binder replacement for improving the temperature resistance or as an aid in graphiting.

The object of the instant invention is to make available a carbon-graphite material with an embedded additive, which is distinguished by a low coefficient of friction and little wear.

This object is essentially attained in accordance with the invention in that the additive is a synthetic mechanically resistant material or several synthetic mechanically resistant materials of a mean grain size between 0.1 and 10 μm.

Carbides, nitrides, borides or mixtures thereof are suitable as synthetic mechanically resistant materials.

Silicon carbide is the preferably employed synthetic mechanically resistant material; further possibilities are silicon nitride and/or boron carbide and/or titanium carbide and/or titanium boride and/or tungsten carbide.

In this case the additives should be a proportion by weight of 1 to 50%, preferably 3 to 15%, of the finished carbon-graphite material.

It has been shown in a surprising manner that by the addition of ultrafine synthetic mechanically resistant materials of a preferred grain size between 0.1 to 2 μm, a carbon-graphite material is being made available whose coefficient of friction and wear could be reduced. This was already shown during a non-lubricated run against a soft, non-alloy steel. In addition it was surprisingly noted that there also was no erosive wear of the contact material. Materials in accordance with the invention also exhibit above-average properties during wet running and against hard contact materials.

A method for producing a carbon-graphite material, wherein fillers such as coke, graphite and carbon black are mixed with one or several additives, such as pitch or synthetic resin, the mixture thus prepared is ground and subsequently pressed and thermally processed, is distinguished in that one or several synthetic mechanically resistant materials of a mean grain size between 0.1 and 10 μm is/are mixed with further fillers and is/are dispersed in the binder. In the process, the fillers in particular are mixed as a whole with such an amount of synthetic mechanically resistant material that following the thermal treatment the proportion by weight of the synthetic mechanically resistant material is 1 to 50 percent by weight, preferably 3 to 15 percent by weight, of the produced carbon and/or graphite material.

In accordance with a further proposal of the invention is provided that the carbon-graphite material in accordance with the invention is used as a lubricating material for bearing rings, seals, slides for pumps or carbon brushes, for example.

Further details, advantages and characteristics of the invention ensue not only from the claims and the characteristics to be found therein—by themselves and/or in combination—but also from the following examples.

### EXAMPLE 1

Basically, conventional methods are used for producing a carbon-graphite material distinguished in accordance with the invention. This means that fillers, such as coke, graphite, carbon black, and the synthetic mechanically resistant materials are mixed with binders, so that the fillers are well wetted and a homogeneous composition results. Grinding to attain a homogeneous grain size then takes place. This is followed by pressing and annealing in an inert or reducing atmosphere.

To produce a carbon-graphite material in accordance with the invention, which is intended for use in a sliding bearing, starter materials with the following proportions by weight are used:

| | |
|---|---|
| Coke: | 8.5% |
| Graphite: | 35% |
| Carbon black: | 15% |
| Synthetic mechanically resistant materials: | 6.5% |
| Binders: | 35% |

The above mentioned materials then were mixed at a temperature T of 220° C. Subsequently the mixture was ground so that a mean grain size of 20 μm resulted.

After pressing and annealing at approximately 1300° C. in an inert atmosphere, the carbon-graphite material exhibited the following properties:

| | |
|---|---|
| Apparent density: | 1.74 g/cm³ |
| Open porosity | 9% |
| Flexural strength | 55 MPa |
| Thermal conductivity | 16 W/mK |
| Coefficient of thermal expansion | 4.5 × 10⁻⁶ K⁻¹ |

During non-lubricated running against steel, the coefficient of friction of a carbon-graphite material shows a coefficient of friction of <0.2. In contrast thereto, a similar material without mechanically resistant materials has a coefficient of friction of 0.3 to 0.35.

1. A carbon-graphite material with an embedded additive,
characterized in that
the additive is/are a synthetic mechanically resistant material or several synthetic mechanically resistant materials with a mean grain size between 0.1 to 10 μm.

2. A carbon-graphite material in accordance with claim 1,
characterized in that
the synthetic mechanically resistant material is silicon carbide.

3. A carbon-graphite material in accordance with claim 1,
characterized in that
the synthetic mechanically resistant material is a carbide and/or nitride and/or boride.

4. A carbon-graphite material in accordance with at least claim 1,
characterized in that
the synthetic mechanically resistant naterial is silicon nitride and/or boron carbide and/or titanium carbide and/or titanium boride and/or tungsten carbide.

5. A carbon-graphite material in accordance with at least claim 1,
characterized in that
in the carbon-graphite material the additives have a proportion by weight of 1 to 50%, preferably 3 to 15%.

6. A method for producing a carbon-graphite material, wherein fillers such as coke, graphite and carbon black are mixed with one or several additives, such as pitch or synthetic resin, the mixture thus prepared is ground and subsequently pressed and thermally processed,
characterized in that
at least one synthetic mechanically resistant material of a mean grain size between 0.1 and 10 μm is dispersed in the binder and mixed with the fillers.

7. A method for producing a carbon-graphite material in accordance with claim 6,
characterized in that
the mechanically resistant material dispersed in the binder is mixed at a temperature T of 200° C.<T≦240° C., preferably T of approximately 220° C.

8. A method for producing a carbon-graphite material in accordance with claim 6,
characterized in that
after grinding and pressing the mixture is annealed at a temperature of approximately 1300° C.

9. A method for producing a carbon-graphite material in accordance with claim 6,
characterized in that
the fillers are mixed as a whole with such an amount of synthetic mechanically resistant material dispersed in the binder, that following the thermal treatment the proportion by weight of the synthetic mechanically resistant material is 1 to 50%, preferably 3 to 15%, of the produced carbon and/or graphite material.

10. Use of the carbon-graphite material in accordance with at least claim 1 as a bearing ring, seal, slide for pumps or carbon brush.
